(19) United States
(12) Patent Application Publication
(10) Pub. No.: US 2024/0364083 A1
(43) Pub. Date: Oct. 31, 2024

(54) CABLE LAYING METHOD

(71) Applicant: NIPPON TELEGRAPH AND TELEPHONE CORPORATION, Tokyo (JP)

(72) Inventors: Tatsuya MOKI, Musashino-shi, Tokyo (JP); Kenji INOUE, Musashino-shi, Tokyo (JP); Hidenobu HIROTA, Musashino-shi, Tokyo (JP); Wataru KOKUBO, Musashino-shi, Tokyo (JP); Yoshiyasu SATO, Musashino-shi, Tokyo (JP)

(73) Assignee: NIPPON TELEGRAPH AND TELEPHONE CORPORATION, Tokyo (JP)

(21) Appl. No.: 18/291,855

(22) PCT Filed: Aug. 16, 2021
(86) PCT No.: PCT/JP2021/029926

§ 371 Date: Jan. 24, 2024

(51) Int. Cl. H02G 1/04

(52) U.S. Cl. CPC H02G 1/04

(57) ABSTRACT

An object of the present invention is to provide a cable laying method that enables efficient work.

A cable laying method according to the present invention includes: preparing a structure 31 having a hook 32; fixing a cable 50 to the hook 32 attached to a surface of the cap-type structure 31 on the ground in the vicinity of a pole 11 built on the ground 10; lifting the structure 31 up to the vicinity of a tip of the pole 11; and covering the tip of the pole 11 with the structure 31. This cable laying method eliminates the need to work in high places. This cable laying method is efficient because it eliminates the need to work in high places.

### TECHNICAL FIELD

The present disclosure relates to a cable laying method for laying a cable on a utility pole.

### BACKGROUND ART

In order to provide a communication service, it is necessary to connect a terminal arranged in a user and a communication device installed in a communication building, by a cable (see NPL 1, for example).

FIG. 1 is a diagram for explaining the structure of poles and the work process that are currently in place (see NPL 2, for example). In order to wire a cable, first, a utility pole 11 is built on the ground 10. Thereafter, a worker 13 rides on a vehicle 14 capable of working at height, and fixes hardware 12 (see NPL 3, for example) that grips the cable, to the utility pole 11.

FIG. 2 is a diagram for explaining the step of wiring a cable 50 in the utility pole 11. This step follows the step shown in FIG. 1. The worker 13 lifts the cable 50 up to the height of the hardware 12. Then, the cable 50 is fixed to the hardware 12, thereby completing the wiring of the cable 50. The cable is wired in this manner.

### CITATION LIST

### Non Patent Literature

[NPL 1] The Institute of Electronics, Communication and Information Engineers Home Page (Cable Laying Technology) https://www.ieice-hbkb.org/files/ad_base/view_pdf.html?p=/files/05/05gun_02hen_04.pdf#page=25
[NPL 2] Information and Communication Engineering Association home page (Construction image collection) http://itea.or.jp/works/pdf/genba03_0810-11_access.pdf
[NPL 3] Iwabuchi Co., Ltd. home page (Typical cable mounting hardware) https://www.iwabuchi.co.jp/seihin/catalog_b/detail01.html

### SUMMARY OF INVENTION

### Technical Problem

Although technological innovation in telecommunications equipment is progressing, technological innovation in the laying of cables is not vigorous. This is because until now it has been possible to arrange for a large number of workers. However, the number of workers has been decreasing in recent years, making it difficult to keep to the construction schedule using the same work methods as before.

To solve the problem described above, an object of the present invention is to provide a cable laying method that enables efficient work.

### Solution to Problem

In order to achieve the above object, a cable laying method according to the present invention includes: a grip portion (hook) for gripping a cable, wherein, by using a structure fitted to a tip of a utility pole, the structure is lifted up in a state where the cable is gripped by the grip portion, to fix the structure to the tip of the utility pole.

Specifically, the cable laying method according to the present invention includes:
fixing a cable to a hook attached to a surface of a cap-type structure on the ground in the vicinity of a pole built on the ground;
lifting the structure up to the vicinity of a tip of the pole; and
covering the tip of the pole with the structure.

In addition, the cable laying method according to the present invention includes:
lifting a cap-type structure up to the vicinity of a tip of a pole built on the ground;
covering the tip of the pole with the structure;
pulling a cable up to the vicinity of the structure; and fixing the cable to a hook attached to a surface of the structure.

This cable laying method enables efficient laying of cables to utility poles without having to work at heights. Therefore, the present invention can provide a cable laying method that enables efficient work.

The cable laying method according to the present invention is characterized in that the shape of the structure is a cylinder or a truncated cone. Work is facilitated by using the structure corresponding to the shape of the utility pole.

The cable laying method according to the present invention is characterized in that the material of the structure is transparent plastic. The work becomes easy if the structure is lightweight. In addition, if the structure is transparent, age-related deterioration of the utility pole can be visually determined, with the structure covered.

The above inventions can be combined as much as possible.

### Advantageous Effects of Invention

The present invention can provide a cable laying method that enables efficient work.

### BRIEF DESCRIPTION OF DRAWINGS

FIG. 1 is a diagram for explaining a current cable laying method.

FIG. 2 is a diagram for explaining the current cable laying method.

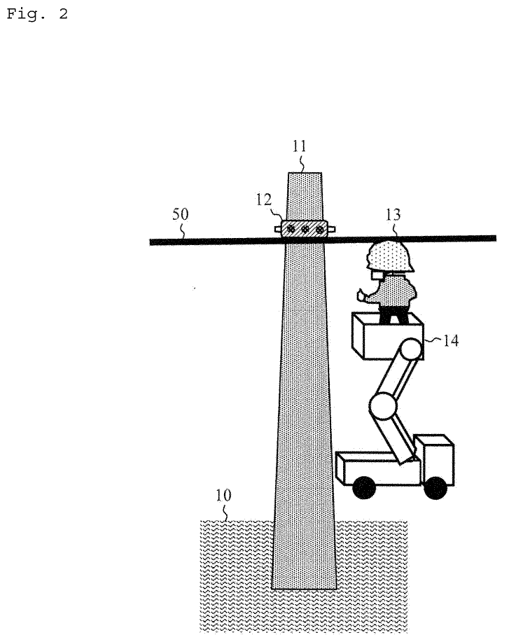

FIG. 3 is a diagram for explaining a cable laying method according to the present invention.

FIG. 4 is a diagram for explaining the cable laying method according to the present invention.

FIG. 5 is a diagram for explaining the cable laying method according to the present invention.

FIG. 6 is a diagram for explaining the cable laying method according to the present invention.

FIG. 7 is a diagram for explaining the cable laying method according to the present invention.

FIG. 8 is a diagram for explaining a structure used in the cable laying method according to the present invention.

FIG. 9 is a diagram for explaining the cable laying method according to the present invention.

FIG. 10 is a diagram for explaining the cable laying method according to the present invention.

FIG. 11 is a diagram for explaining the cable laying method according to the present invention.

FIG. 12 is a diagram for explaining the cable laying method according to the present invention.

FIG. 13 is a diagram for explaining the cable laying method according to the present invention.

FIG. 14 is a diagram for explaining the cable laying method according to the present invention.

FIG. 15 is a diagram for explaining the cable laying method according to the present invention.

FIG. 16 is a diagram for explaining the cable laying method according to the present invention.

FIG. 17 is a diagram for explaining the cable laying method according to the present invention.

FIG. 18 is a diagram for explaining the cable laying method according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that, in the present specification and the drawings, components having the same reference numerals indicate the same components.

### Embodiment 1

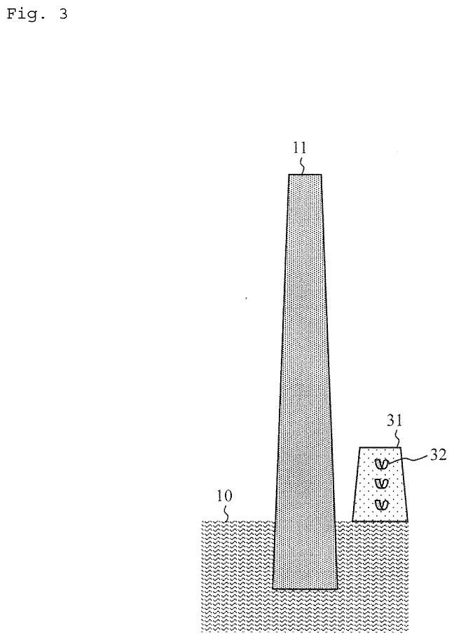

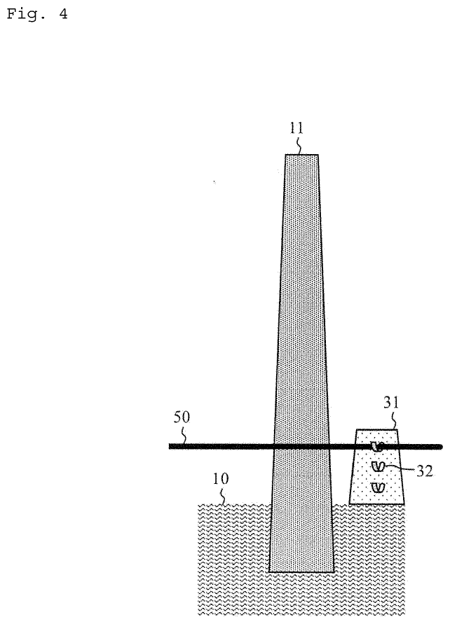

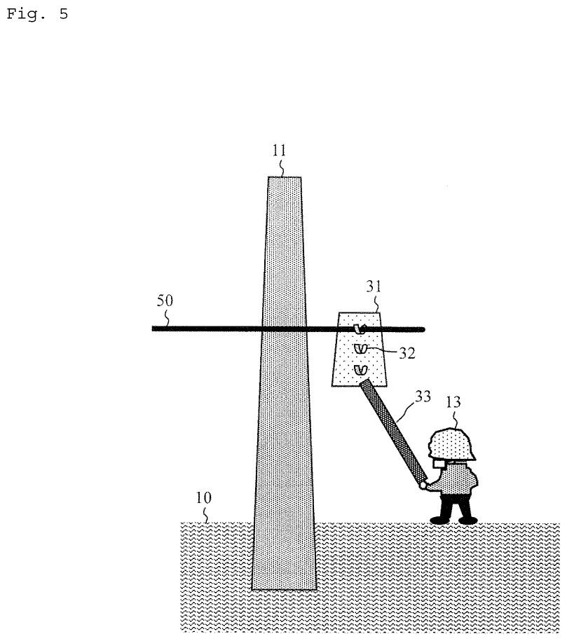

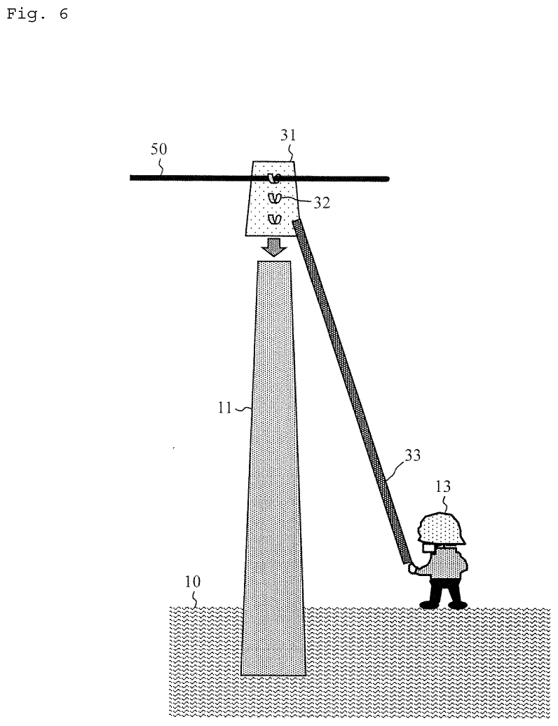

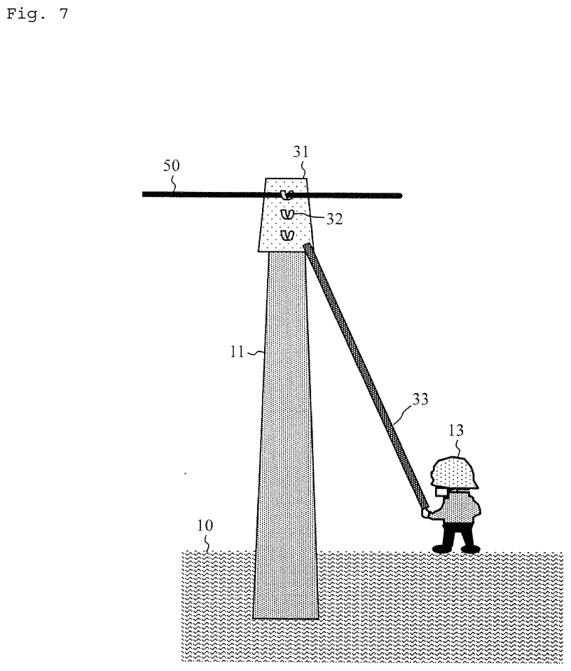

FIGS. 3 to 7 are diagrams for explaining a cable laying method of the present embodiment. This cable laying method includes:
(FIG. 3) preparing a structure 31 having a hook 32;
(FIG. 4) fixing a cable 50 to the hook 32 attached to a surface of the cap-type structure 31 on the ground in the vicinity of a pole 11 built on the ground 10;
(FIG. 5) lifting the structure 31 up to the vicinity of a tip of the pole 11; and
(FIGS. 6 and 7) covering the tip of the pole 11 with the structure 31.

The details of work will be described below. First, the cap-type structure 31 with the cable anchoring hook 32 is placed on the ground 10 (FIG. 3). The cable 50 is fixed to the structure 31 (FIG. 4). Then, a worker 13 lifts up the structure 13 to which the cable 50 is fixed, by using a lifting rod 33, and moves the structure 13 to the tip of the utility pole 11 (FIG. 5). Then, the tip of the utility pole 11 and the structure 13 are fitted to each other, thereby completing the work (FIGS. 6 and 7).

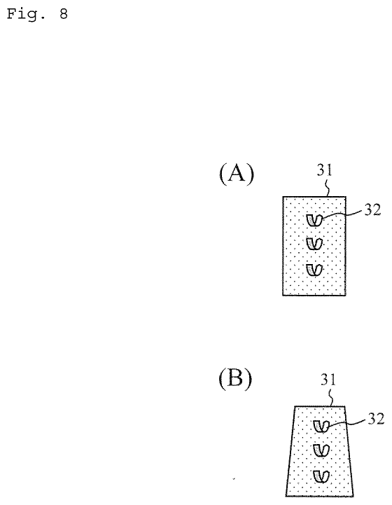

As shown in FIG. 8, there are two types of structures 31, that is, (a) a cylindrical shape or (B) a truncated cone shape having a taper, in accordance with the shape of the tip of the utility pole 11.

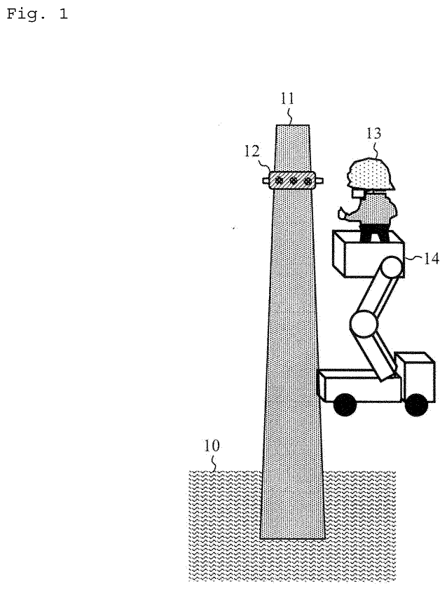

In the conventional cable laying method, a vehicle 14 for performing work at height is required as shown in FIG. 1, but according to the cable laying method of the present invention, it is not necessary to perform work at height. This cable laying method is efficient because it eliminates the need to work in high places.

### Embodiment 2

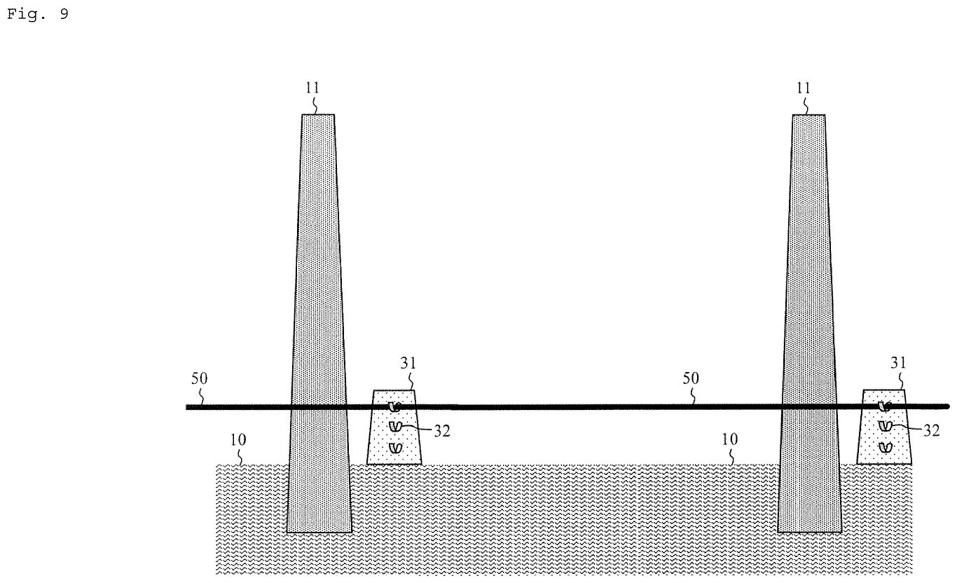

In the present embodiment, a method for laying cables on a plurality of utility poles will be described with reference to FIGS. 9 to 12. First, the cap-type structure 31 with the cable anchoring hook 32 is placed on the ground 10 in the vicinity of each utility pole 11. Cables 50 are fixed to these structures 31 (FIG. 9).

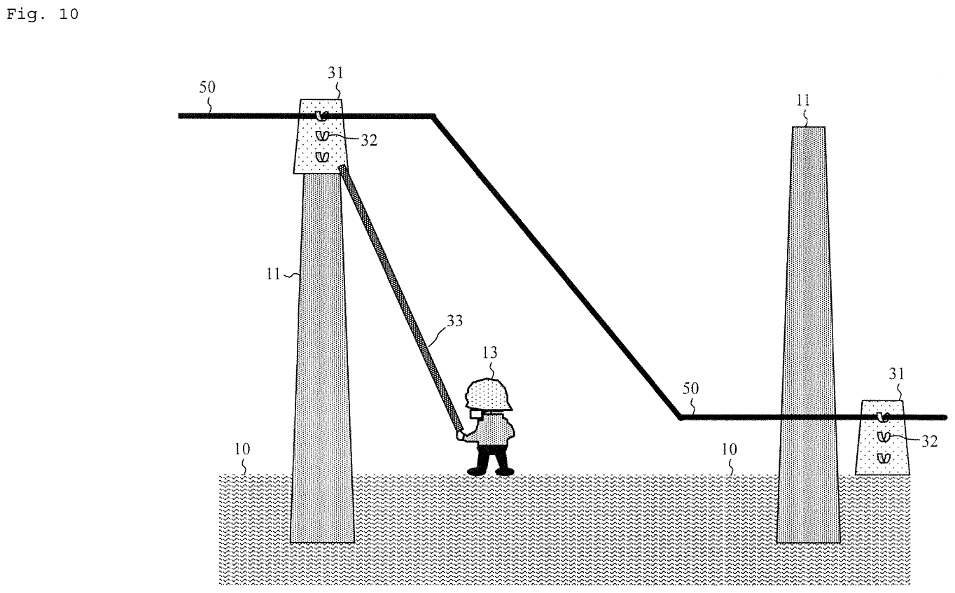

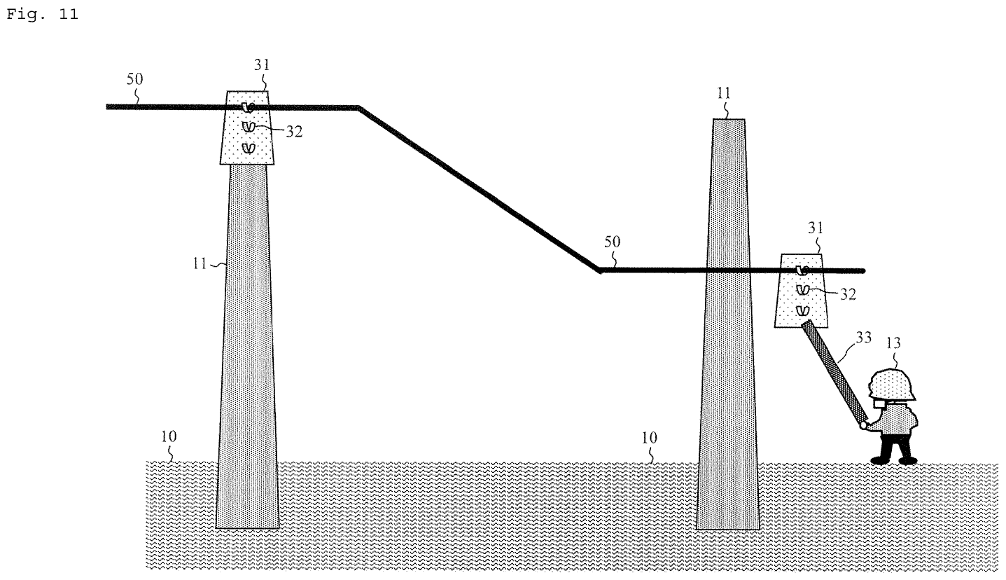

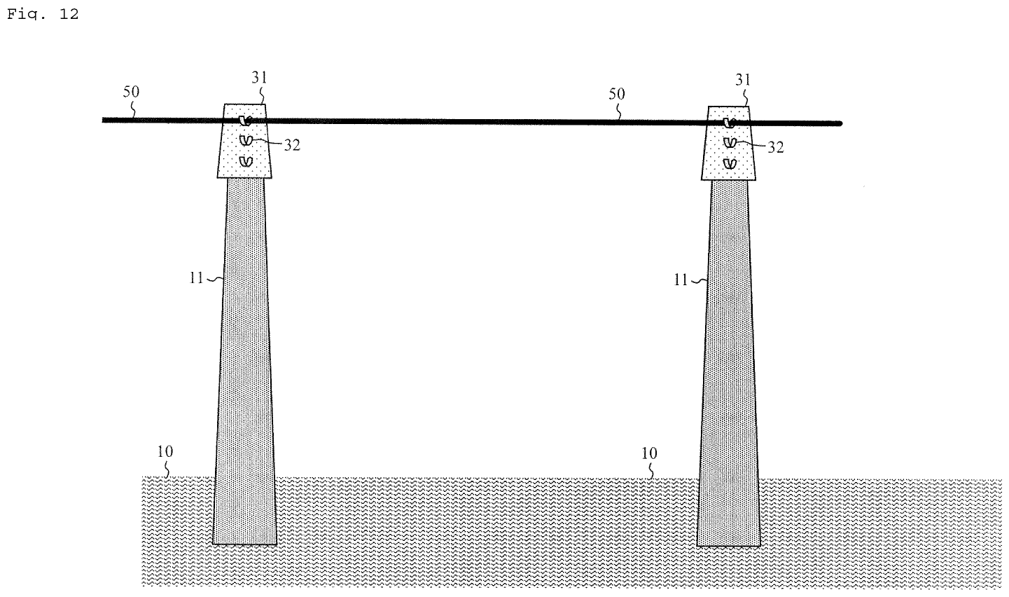

As described in Embodiment 1, the structure 31 is put on and fitted to the tip of the first utility pole 11 (FIG. 10). As for the next second utility pole 11, the worker 13 lifts the structure 31 up to the tip of the utility pole 11 by using the lifting rod 33 (FIG. 11), and fits the structure 31 to the tip of the utility pole 11 (FIG. 12), as in the description of Embodiment 1. By repeating such work, cables can be laid on a plurality of utility poles.

### Embodiment 3

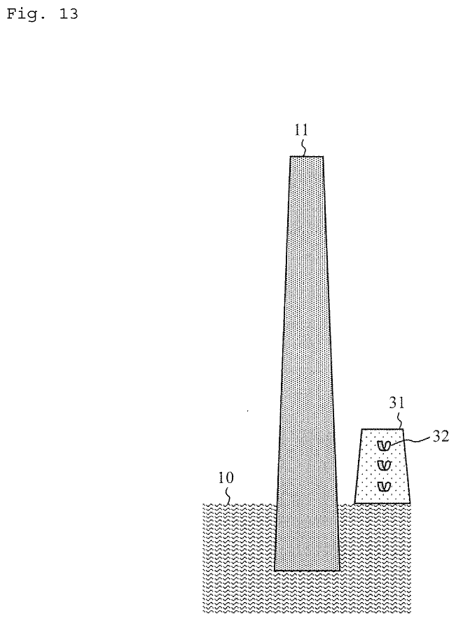

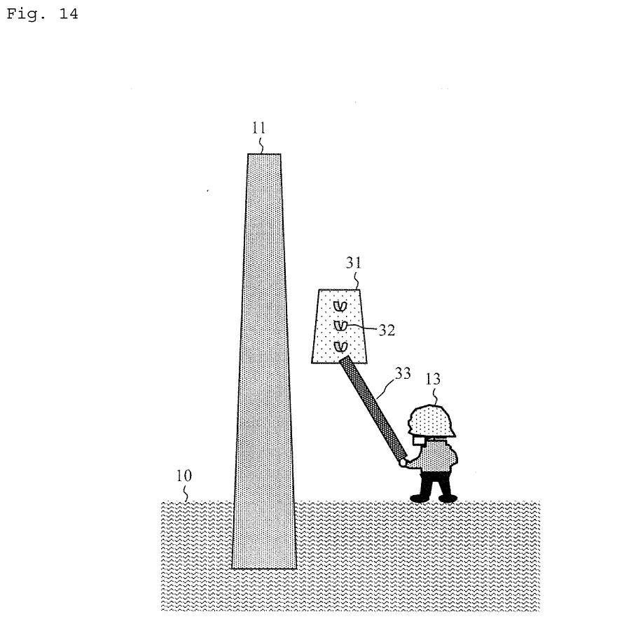

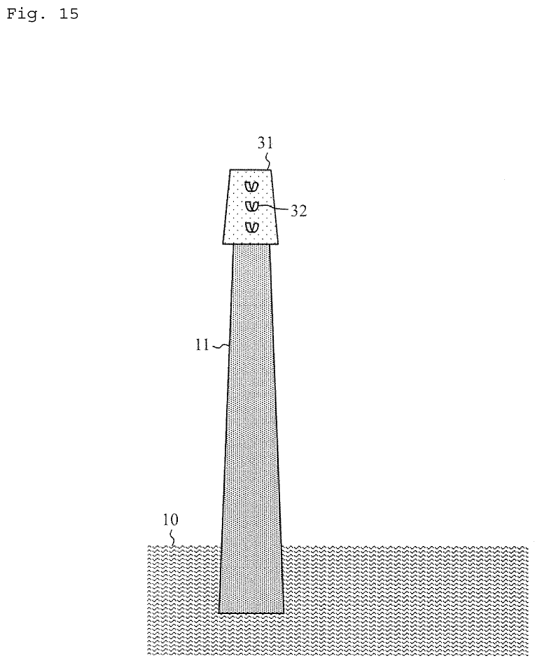

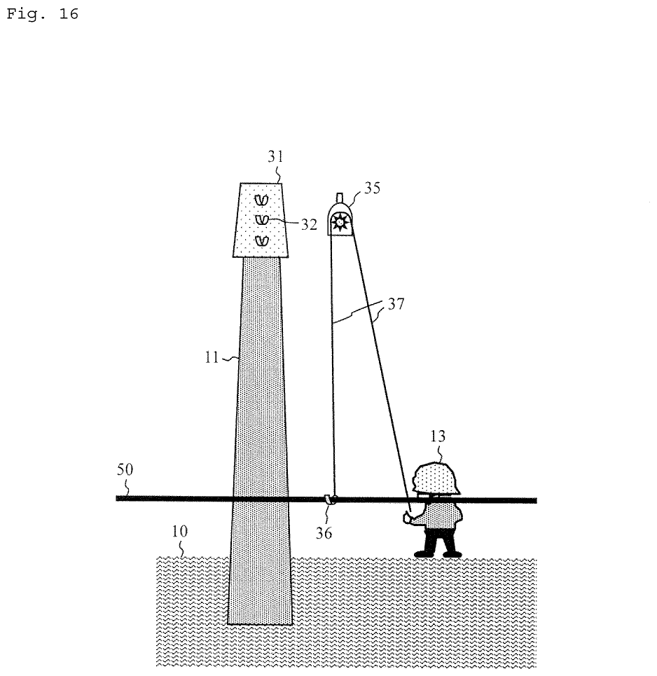

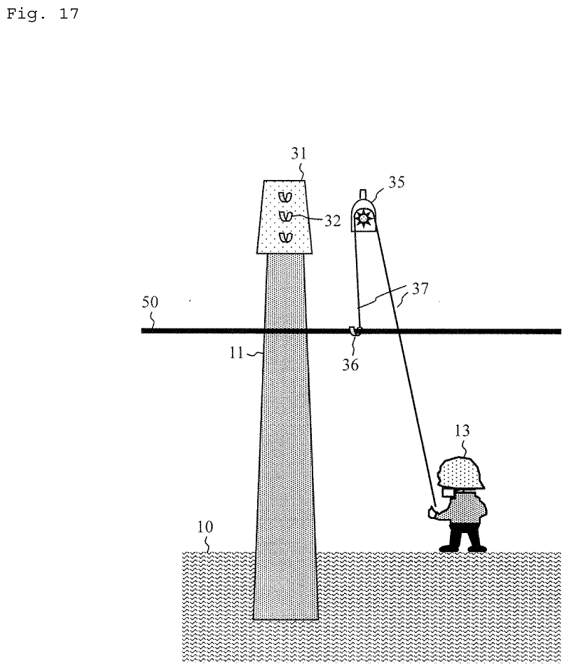

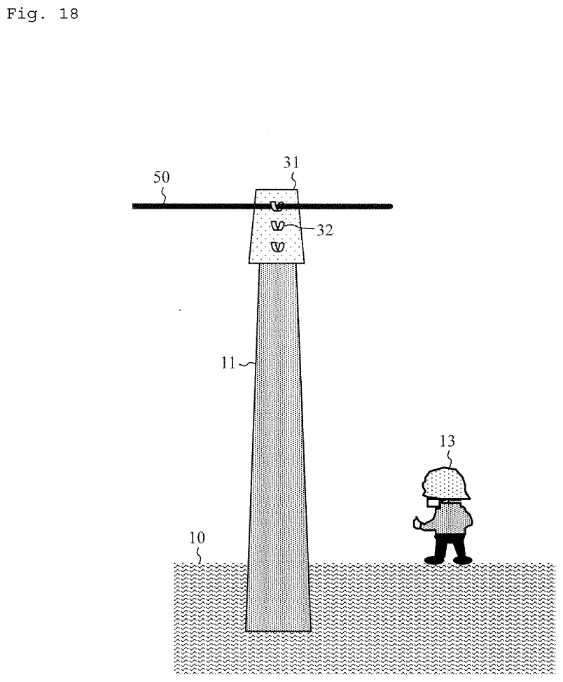

FIGS. 13 to 18 are diagrams for explaining a cable laying method of the present embodiment. This cable laying method includes:
(FIG. 13) preparing the structure 31 having the hook 32;
(FIG. 14) lifting the cap-type structure 31 up to the vicinity of the tip of the pole 11 built on the ground 10;
(FIG. 15) covering the tip of the pole 11 with the structure 31;
(FIGS. 16 and 17) pulling the cable 50 up to the vicinity of the structure 31; and
(FIG. 18) fixing the cable 50 to the hook 32 attached to the surface of the structure 31.

The details of work will be described below. First, the cap-type structure 31 with the cable anchoring hook 32 is placed on the ground 10 in the vicinity of the utility pole 11 (FIG. 13). Then, the worker 13 lifts the structure 31 up to the tip of the utility pole 11 by using the lifting rod 33 (FIG. 14). The structure 31 is put on and fixed to the tip of the utility pole 11 (FIG. 15). Then, a pulley 35 and the cable 50 are prepared. The cable 50 is fixed to a hook 36 of the pulley 35 (FIG. 16). The worker 13 pulls a rope 37 of the pulley 35 to lift the cable 50 up to the tip of the utility pole 11 (FIG. 17). Finally, the cable 50 is hooked and fixed onto the hook 32 of the structure 31, thereby completing the laying of the cable (FIG. 18).

### Embodiment 4

If the structure 31 covering the tip of the utility pole 11 is not transparent, the tip of the utility pole 11 is covered and cannot be visually observed. Since the utility pole 11 installed outdoors is installed for many years, the soundness of the pole must be able to be checked at any time.

Obviously, if the structure 31 is made of the same material as the utility pole, such as concrete, the tip of the utility pole 11 becomes covered and cannot be checked. Furthermore, the concrete is heavy, making it difficult for the worker 13 to lift up the structure by using the rod 33. Therefore, it is preferred that the material of the structure 31 covering the tip of the utility pole 11 be lightweight and transparent and can be prepared in large quantities on the industrial scale. Therefore, the material of the structure 31 is made of transparent plastic that is widely distributed and has excellent workability.

### REFERENCE SIGNS LIST

10: Ground
11: Utility pole (pole)
12: Cable anchoring hardware
13: Worker
14: Vehicle
31: Structure
32: Hook
33: Lifting rod
35: Pulley
36: Hook
37: Rope
50: Cable

1. A cable laying method, comprising:
fixing a cable to a hook attached to a surface of a cap-type structure on the ground in the vicinity of a pole built on the ground;
lifting the structure up to the vicinity of a tip of the pole; and
covering the tip of the pole with the structure.

2. The cable laying method, comprising:
lifting a cap-type structure up to the vicinity of a tip of a pole built on the ground;
covering the tip of the pole with the structure;
pulling a cable up to the vicinity of the structure; and
fixing the cable to a hook attached to a surface of the structure.

3. The cable laying method according to claim 1, wherein the structure has a cylindrical shape or a truncated cone shape.

4. The cable laying method according to claim 1, wherein the structure is made of transparent plastic.
